(19) United States
(12) Patent Application Publication
(10) Pub. No.: US 2007/0081162 A1
(43) Pub. Date: Apr. 12, 2007

(54) Method And Apparatus For Determining Marker Gas Concentration Using An Internal Calibrating Gas

(75) Inventors: Chad Roller, Oklahoma City, OK (US); Khosrow Namjou, Norman, OK (US); James Jeffers, Norman, OK (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: Ekips Technologies, Inc., Norman, OK (US)

(21) Appl. No.: 11/610,997

(22) Filed: Dec. 14, 2006

Related U.S. Application Data
(63) Continuation-in-part of application No. 10/338,353, filed on Jan. 8, 2003.
(60) Provisional application No. 60/347,513, filed on Jan. 11, 2002.

(51) Int. Cl. G01N 21/61

(52) U.S. Cl. 356/437

(57) ABSTRACT

A method and an apparatus for measuring the concentration of a specific gas component of a gas mixture including another gas whose concentration is independently known using light absorption spectroscopy are provided. A method and an apparatus for assessing human airway inflammation by measuring the concentration of exhaled NO and CO₂ present in orally exhaled breath using light absorption spectroscopy are also provided. NO concentration is determined at the time during breath sampling corresponding to a known exhaled CO₂ concentration. Methods and apparatus are further provided for measuring NO concentration in orally exhaled human breath that analyze breath emanating from the lower airways and lungs, while excluding breath from the nasal cavity. They include steps and apparatus for discarding initially exhaled breath, flowing breath through an analysis chamber using a vacuum pump and flowing breath through an analysis chamber using a vacuum pump at an initial flow rate and later at a flow rate higher than the initial flow rate.

### CROSS REFERENCE TO RELATED APPLICATIONS

This application is a continuation-in-part of U.S. patent application Ser. No. 10/338,353 filed Jan. 8, 2003 which claims the benefit of U.S. Provisional Patent Application No. 60/347,513 filed Jan. 11, 2002.

### FIELD OF THE INVENTION

The invention relates to methods and apparatus for determining the concentration of a gas in a mixture.

### DESCRIPTION OF THE PRIOR ART

Gas mixtures are routinely analyzed in fields ranging from medical diagnostics to automobile design. Techniques used vary widely and include mass spectroscopy, infrared spectroscopy, chemiluminescence, and flame ionization. Regardless of the application, accuracy, reliability, convenient operation, low cost and preferably real-time analysis results are desirable. In the field of medical diagnostics, convenient, patient-friendly operation and real-time delivery of results are crucial for successful clinical implementation.

Currently available methods for determining the concentration of a gas in a mixture typically require use of a reference as in U.S. Pat. No. 5,640,014 to Sauke et al. wherein a reference signal or reference gas is used in a diode laser spectroscopy method to determine the isotopic ratio of a gas in a sample. Other methods involve deliberate introduction of a trace gas to the gas mixture to be analyzed as in U.S. Pat. No. 6,412,333 to Inoue et al. U.S. Pat. No. 6,412,333 describes an auto exhaust analyzer system and method wherein a trace gas is introduced into the exhaust gas stream, the mass of the trace gas is calculated using the analyzer and the calculated mass then compared with the known mass of trace gas to verify the accuracy of the analysis. Still other techniques compensate for inaccuracy in non-dispersive infrared analysis using signal processing techniques such as U.S. Pat. No. 5,464,983 to Wang which describes measurement of change of signal (CS) and change of change of signal (CCS) and comparison of CCS data obtained to CCS data for known gases at known concentrations and temperatures.

In the field of medical diagnostics, nitric oxide (NO) is a well-established indicator of pulmonary function. Analysis of exhaled NO (“eNO”) provides a health care provider with a non-invasive test for inflammatory diseases of the lower airways such as asthma. Widely used diagnostic tests for asthma such as spirometry give only limited and indirect information about lower airway inflammation. Current methods measuring eNO for assessing lung function, such as U.S. Pat. No. 5,447,165 to Gustafsson, use mass spectroscopy and chemiluminescence to measure the time distribution of NO formed during exhalation and require that results be compared with unimpaired lung function of a living subject reference. U.S. Pat. No. 6,099,480 to Gustafsson describes collection of human breath and analysis for NO content using chemiluminescence or reagent-based chemical analysis techniques. U.S. Pat. No. 6,419,634 to Gaston et al. uses reagent-based colorimetric NO assay analysis of exhaled human breath condensate to evaluate airway inflammation. Each of these methods requires frequent calibration of the NO sensor using a calibration gas with a known NO concentration. This requirement complicates use of such sensing technology in a clinical setting.

Endogenous NO emanating from the airways and lungs is the preferred indicator of airway inflammation. Hence, breath collection techniques to collect this endogenous NO while excluding nasal eNO from study have been developed. U.S. Pat. No. 6,010,459 to Silkoff et al. requires a patient to exhale at a constant rate and increased pressure in the mouth to close off the nasopharynx during exhalation thereby excluding nasal eNO. U.S. Pat. No. 6,038,913 to Gustafsson et al. requires that a patient exhale against a back pressure during the later phase of an exhalation. U.S. Pat. No. 5,922,610 to Alving et al. describes a face mask that tightly covers the nose and/or mouth of the subject. Such techniques that require controlled exhalation by a patient can be difficult for those patients with impaired respiratory function and especially for pediatric patients.

Thus, there exists a need for accurately determining, the concentration of a specific gas of interest in an as-obtained gas mixture sample without introduction of any additional reference gas. There exists further need for accurately assessing airway inflammation, using a single exhaled breath from a single patient Preferably, such airway inflammation assessment is conveniently conducted in a clinical setting, maximizes patient comfort and provides real-time results that can enable a health care provider to diagnose and treat a patient in a single clinic visit

### SUMMARY OF THE INVENTION

The present invention is directed to a spectrometer system for measuring the concentration of a marker gas in a gas mixture. The system comprises a spectrometer gas sample cell, a spectrometer light source, a spectrometer detector, and a spectrometer computer. The spectrometer light source is adapted to pass a light beam through the gas sample cell. The spectrometer detector is adapted to produce a signal sampling characteristic of the gas sample in response to light passing through the gas mixture. The spectrometer computer is adapted to acquire the signal sampling from the spectrometer detector over a signal acquisition interval and generate a spectrum indicative of the gas sample. The spectrometer computer is further adapted to analyze the spectrum to determine a marker gas absorption intensity and a calibration gas absorption intensity as a function of time over a plurality of signal acquisition intervals to identify a signal acquisition interval where a known concentration calibration gas absorption intensity corresponds to an independently known calibration gas concentration and a simultaneous marker gas absorption. The spectrometer computer is further adapted to calculate a ratio of the simultaneous marker gas absorption intensity to the known concentration calibration gas absorption intensity and multiplying the ratio by a proportionality constant to determine concentration of the marker gas.

The present invention is further directed to a method for comparing a concentration of a marker gas to a concentration of a calibration gas where the calibration gas and marker gas are intrinsic in a gas sample and where the calibration gas has an independently known concentration. The method comprises placing the gas mixture sample in a spectrometer gas sample cell over a sampling interval and illuminating the gas mixture sample within the spectrometer gas sample cell over the sampling interval to generate a signal sampling characteristic of the gas mixture sample. The method further comprises generating a plurality of gas mixture spectra and analyzing the gas mixture spectra to measure marker gas intensity and calibration gas intensity for each of the plurality of spectra as a function of time over the sampling interval. A single spectrum is identified where known concentration calibration gas intensity corresponds to an independently known calibration gas concentration and simultaneous marker gas intensity. A ratio of the simultaneous marker gas intensity to the known concentration calibration gas intensity is calculated and multiplied by a proportionality constant to determine a concentration of the marker gas.

### BRIEF DESCRIPTION OF THE DRAWINGS

FIG. 1 is a block diagram summarizing steps of acquiring and analyzing gas mixture spectra to determine concentration of a gas mixture component.

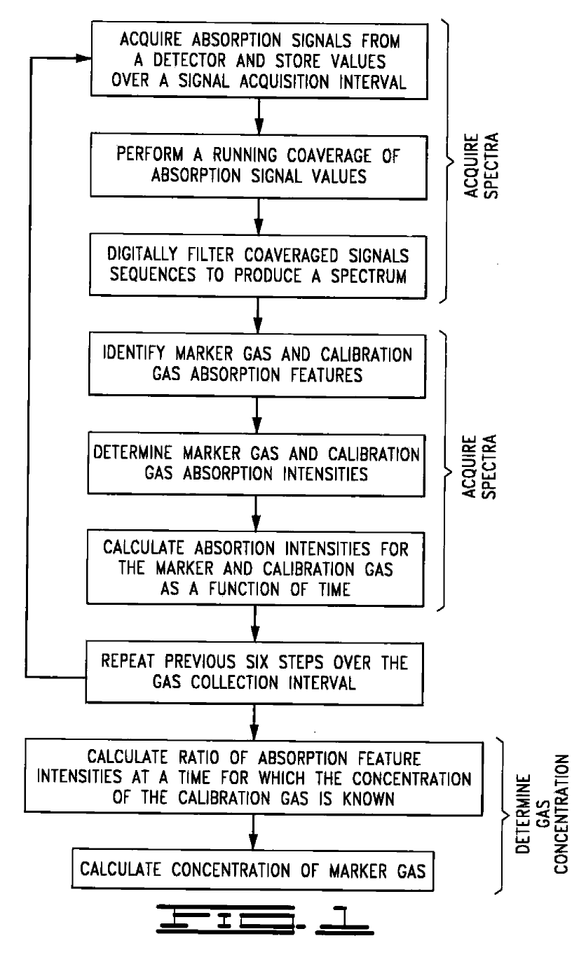

FIG. 2 is a schematic drawing of a gas mixture analysis system.

FIG. 3 is a plot of NO and CO₂ absorption line intensities in the 5.2 μm region of the infrared spectrum using data from the HITAN '96 database.

FIG. 4 is a schematic drawing of a breath collection and analysis apparatus and the TLAS system equipped with an IV-VI mid-infrared laser.

FIG. 5 is a schematic drawing of a breath collection and analysis apparatus including a container for collecting initially exhaled breath.

FIG. 6 is a schematic drawing of a breath collection and analysis apparatus.

FIG. 7 is a schematic drawing of a breath collection and analysis apparatus including a flow controller

FIG. 8 is a second harmonic spectrum of exhaled alveolar-enriched human breath measured between 1912.5 cm⁻¹ and 1913.0 cm⁻¹ showing absorption features for NO and CO₂.

FIG. 9 is gas calibration curve obtained by measuring concentrations of NO produced using a gas dilution system.

FIG. 10 is a plot showing measured second harmonic absorption of NO (1912.79 cm⁻¹) for NO concentrations of 50 ppb, 124 ppb, 244 ppb, and 475 ppb.

FIG. 11 is a plot showing two comparison spectra (Comp. #1 and Comp. #2) at varying unknown concentrations of NO and CO₂.

FIG. 12 is a plot showing exhalation trends over a 20 second exhalation of eNO and eCO₂ measured from an asthmatic subject and a nonasthmatic subject.

FIG. 13 is a plot showing absorption magnitude of NO vs. time for 100 ppb NO gas flowed through a spectrometer gas sample cell for 20 seconds and for a subject's breath for a 20 second exhalation.

FIG. 14 is a plot of calibrated eNO breath measurements quantified using a 50 ppb NO gas standard versus eNO concentrations calculated using the eCO₂ absorption magnitudes and Equation (3).

FIG. 15 is a plot showing absorption magnitudes of eNO and eCO₂ as a function of time for varying exhalation times of 5, 10 and 15 seconds.

FIG. 16 is a plot of exhalation trends for eCO₂ at varying gas sample cell pressures between 13 Torr (1.7 kPa) and 33 Torr (4.4 kPa).

FIG. 17 is a plot of calculated eNO concentrations obtained using Equation (3) at varying pressures between 13 Torr and 40 Torr along with the eNO concentration mean, μ_{eNO}, and standard deviation, σ_{eNO}.

FIGS. 18(a) and 18(b) are plots showing breath eNO and eCO₂ exhalation trends measured from a nonasthmatic subject at different ambient NO levels.

FIG. 19 is a plot showing concentrations of eNO obtained using Equation (3) over a period of 10 days for an astimatic patient undergoing a corticosteroid treatment regimen and for a non-asthmatic subject over the same time period.

### DESCRIPTION OF PREFERRED EMBODIMENTS

The invention provides a method and apparatus for spectroscopically measuring the concentration of a particular marker gas in a gas mixture using another gas inherently present in the mixture and whose concentration is known independently as an internal calibration gas. Thus, the invention obviates the need for a separate reference or for deliberate introduction of any reference or trace gas to the gas mixture.

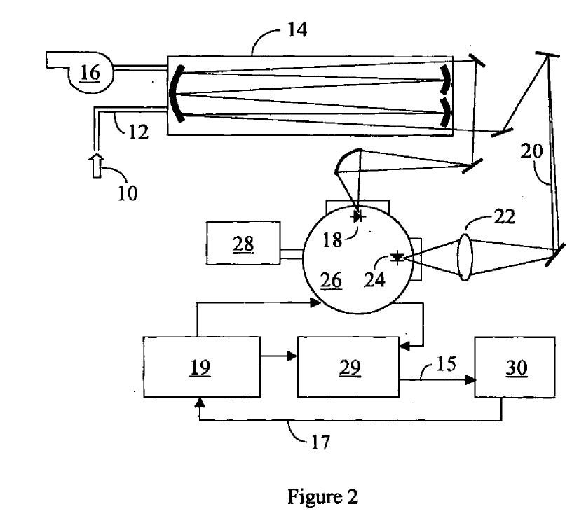

FIG. 2 shows a preferred embodiment of the invention. A gas mixture sample, represented by arrow 10 is introduced via tubing 12 into a spectrometer sample cell, specifically White cell 14. A Herriott cell can also be used as the spectrometer sample cell. Mechanical vacuum pump 16 evacuates White cell 14 to keep White cell 14 at a pressure selected to reduce line broadening and interference between the spectroscopic absorption associated respectively with the marker gas and calibration gas. Gas mixture sample 10 can be human breath having marker gases such as NO, N₂O, C₂H₆, CH₂O, C₂H₄O, H₂O₂; CO, CO₂, CS₂, CH₃O, NH₃, H₂S, or OCS whose presence and concentration can be correlated with a disease. Calibration gases present in a human breath sample can be CO₂, H₂O, N₂O or CH₄. For example, exhaled ethane (C₂H₆) may be a marker and methane a calibration gas for diagnosing oxidative stress damage resulting from lipid-peroxidation as described in Clinical Application of Breath Biomarkers of Oxidative Stress Status, Free Rad. Biol. & Med. 27, 1182-1192 authored by Risby et al., the contents of which are incorporated herein by reference. Exhaled formaldehyde (CH₂O), with H₂O as an internal calibrating gas, has been shown to be a marker for breast cancer in Quantitative Analysis by Gas Chromatography of Volatile Carbonyl Compounds in Expired Air from Mice and Human, J. Chromatogr. B. Biomed. Sci. Appl. 702, 211-215 by Ebeler et al., the contents of which are also incorporated by herein by reference. Formaldehyde has also been shown to be a marker for bladder or prostrate cancer in urine analyzed by ion flow tube mass spectrometry as taught in Analysis of Formaldehyde in the Headspace or Urine from Bladder and Prostrate Cancer Patients Using Selected Ion Flow Tube Mass Spectrometry, Rapid Commun. Mass Spectrometry 13, 1354-1359 by Spanel et al., the contents of which are incorporated herein.

The concentration of Carbon Disulfide (CS₂) levels in exhaled breath, with H₂O as an internal calibrating gas, has been shown to be a marker for schizophrenia in an article entitled Increased Pentane and Carbon Disulfide in the Breath of Patients with Schizophrenia, J. Clinical Pathology 46, 861-864 by Phillips et al., the contents of which are incorporated herein by reference. Additionally, carbon disulfide in exhaled breath may be measured, using CO₂ as an internal calibrating gas, to diagnose toxic exposure in industrial workers as described in Detection of Carbon Disulfide in Breath and Air: A Possible New Risk Factor for Coronary Artery Disease, Int. Arch. Occup. Env. Health 64, 119-123 by Phillips, the contents of which are incorporated herein by reference.

The measurement of carbonyl sulfide (COS) levels in exhaled breath, using CO₂ as an internal calibrating gas, has been shown to have applications in diagnosing acute lung transplant rejection and liver disease as described in Patterns and Significance of Exhaled-breath Biomarkers in Lung Transplant Recipients with Acute Allograft Rejection, J. Heart Lung Transplant 20, 1158-1166 by Studer et al. and Breath Biomarkers for Detection of Human Liver Diseases: Preliminary Study, Biomarkers 7, 174-187 by Sehnert et al., the contents of which are both incorporated herein by reference, The measurement of acetaldehyde (C₂H₄O) concentrations in exhaled breath has been shown to have application in determining metabolic rates of ethanol metabolism as taught in The Role of Acetaldehyde in Pregnancy Outcome After Prenatal Alcohol Exposure, Ther. Drug Monitoring 23, 427-434, by Hard et al. and an article by A. W. Jones entitled Measuring and Reporting the Concentration of Acetaldehyde in Human Breath, Alcohol & Alcoholism 30, No. 3, 271-285, 1995, the contents of both which are incorporated herein by reference.

The spectrometer can be a mid-infrared tunable laser absorption spectroscopy system where the spectrometer light source that illuminates the gas mixture sample is IV-VI diode laser 18 with an emission wavelength in the range of from about 3 μm to about 10 μm controlled by current driver/function generator assembly 19 and personal computer 30 as shown schematically by arrow 17.

Transmitted light beam 20 that has passed through gas mixture sample 10 in White cell 14 can be focused with lens 22 onto spectrometer detector 24 which is maintained s with IV-VI diode laser 18 at reduced temperature in cryostat 26. Cryostat 26 is evacuated using ion pump 28. Spectrometer detector 24 generates a signal sampling which can be acquired by lock-in amplifier 29 after amplification by a preamp (not shown) and personal computer 30, equipped with an analog-to-digital (A/D) card to produce a gas mixture spectrum. The gas mixture spectrum can be a second harmonic absorption spectrum. Arrow 15 represents signals transmitted from lock-in amplifier 29 to personal computer 64. The gas mixture spectrum can be generated by digitally filtering a running co-average of at least two detector signal samplings which have been obtained and stored in personal computer 30.

The invention further provides a method and apparatus for assessing human airway inflammation by measuring the concentration of NO, a marker gas associated with human body tissue inflammation. The NO is present together with CO₂ in orally exhaled human breath. Since the concentration of CO₂ in orally exhaled human breath is known, it serves as an internal calibration gas. NO and CO₂ spectroscopic absorption intensities are identified, obtained and stored repeatedly to find a signal sampling interval wherein the CO₂ gas absorption intensity corresponds to a known CO₂ concentration. The CO₂ gas absorption intensity that corresponds to the independently known CO₂ concentration is the maximum CO₂ gas absorption intensity obtained over the entire time a human subject exhales, the exhalation interval. The NO gas absorption intensity obtained simultaneously with the CO₂ gas absorption intensity corresponding to an independently known CO₂ concentration in the range of from about 4% to about 5% is subsequently used in a ratio calculation to obtain the NO concentration which is an indicator for human airway inflammation. Exhaled NO concentration in the range of from about 5 parts per billion (ppb) to about 100 parts per billion (ppb) is indicative of airway inflammation.

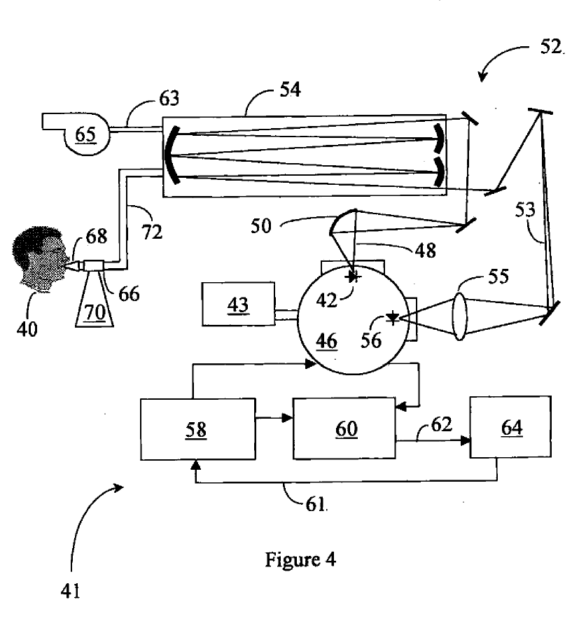

As shown in FIG. 4, human subject 40 orally exhales so that orally exhaled breath enters spectrometer system 41. Human subject 40 orally exhales into mouthpiece 68. Mouthpiece 68 is connected with T-piece 66, while T-piece 66 is further connected to discard container 70 and tubing 72. A one-way flutter valve, not shown, can be connected between T-piece 66 and discard container 70 to keep initially orally exhaled breath in discard container 70. All connections allow for passage of orally exhaled human breath. Tubing 72 carries orally exhaled breath to gas sample cell 54. Spectrometer gas sample cell 54, which can be a Herriott cell or multi-pass White cell, can be kept at a pressure chosen to reduce line broadening as well as interference between absorption characteristics associated, respectively, with the NO and CO₂ present in the orally exhaled breath sample. Human subject 40 can orally exhale a single breath as he or she would normally do while breathing not under test conditions so that breath provided at the beginning of the exhalation, initial exhaled breath, is collected in discard container 70 and is not analyzed by the spectrometer. After discard container 70 is filled, the rest of the breath from the single breath, remaining exhaled breath enters spectrometer gas sample cell 54 for spectroscopic analysis. Orally exhaled human breath can also be introduced into spectrometer gas sample cell 54 using mechanical vacuum pump 65 connected to spectrometer gas sample cell 54 by tubing 63 alone or together with the already described discard container 70 to induce flow of the orally exhaled human breath through spectrometer gas sample cell 54. The flow rate of orally exhaled human breath through spectrometer gas sample cell 54 can be varied using flow rate controllers not shown so that the breath first flows through spectrometer gas sample cell 54 at a first flow rate greater than a later, second flow rate.

Spectrometer system 41 can be a mid-infrared tunable laser absorption spectroscopy system and can have an IV-VI diode laser 42 with an emission wavelength in the range of from about 3 μm to about 10 μm as the light source to illuminate the orally exhaled human breath sample contained in gas sample cell 54. Spectrometer detector 56 generates detector signal samplings in response to detection of light beam 53 that has been transmitted through the orally exhaled human breath sample contained in gas sample cell 54. Detector signal samplings are acquired by lock-in amplifier 60 after amplification by a preamp (not shown) spectrometer computer 64 to generate a human breath sample spectrum which can be a second harmonic absorption spectrum. Arrow 62 represents signals transmitted from lock-in amplifier 60 to personal computer 64. A running co-average of at least two previously obtained and stored detector signal samplings can be performed and the result digitally filtered to generate the human breath sample spectrum.

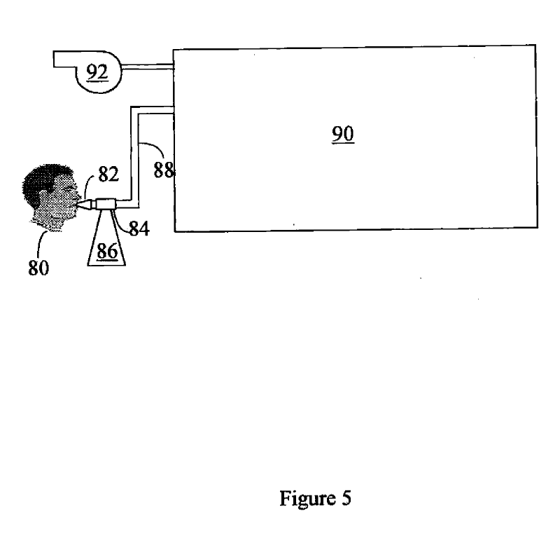

The invention also provides a method and apparatus for measuring NO concentration in orally exhaled human breath generally applicable for use with a wide variety of analysis systems capable of measuring NO concentration utilizing a discard container to eliminate initial exhaled breath from analysis. FIG. 5 shows human subject 80 orally exhaling a single breath as he or she would do when breathing normally, into mouthpiece 82 connected via T-piece 84 to discard container 86 and flow tube 88. Breath provided at the beginning of the exhalation, initial exhaled breath, is collected in discard container 86 and is discarded, i.e., not analyzed. After discard container 86 is filled, the rest of the breath from the single breath, remaining exhaled breath, enters NO analysis system 90 through flow tube 88. Mechanical vacuum pump 92 is connected to NO analysis system 90 and flow tube 88 so that orally exhaled human breath flows through the NO analysis system. Mechanical vacuum pump 92 can be operated to produce a vacuum in the spectrometer gas sample cell 54 in the range of from about 10 Torr to about 80 Torr. The flow rate resulting from pumping on the system with mechanical vacuum pump 92 can be in the range of from about 0.5 liters per minute to about 30 liters per minute. NO analysis system 90 can be a light absorption spectrometer, such as a mid-infrared tunable laser absorption spectrometer.

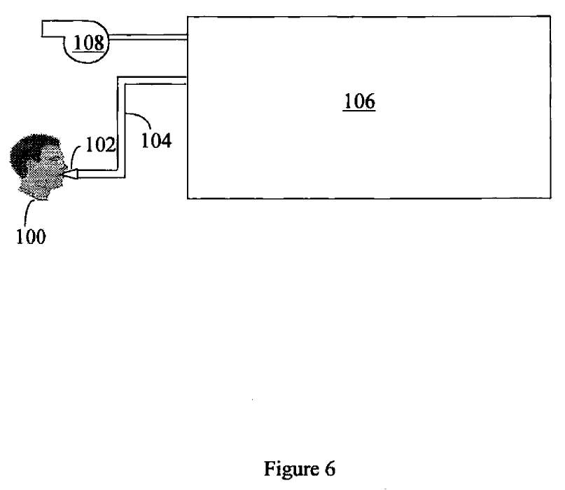

The invention provides a method and apparatus to measure NO concentration in orally exhaled human breath wherein a single breath is delivered to an NO light absorption spectrometer system through a tube maintained at a reduced pressure provided by a vacuum pump so that the patient need only provide a single breath exhaled normally through the mouth. FIG. 6 shows human subject 100 orally exhaling a single breath as he or she would do when breathing normally into mouthpiece 102 connected to flow tube 104. All orally exhaled breath enters NO light absorption spectrometer analysis system 106 through flow tube 104. Mechanical vacuum pump 108 is connected to NO light absorption spectrometer system 106 and flow tube 104 so that orally exhaled human breath flows through the NO light absorption spectrometer system. Mechanical vacuum pump 108 can be operated to produce a vacuum in the range of from about 10 Torr to about 80 Torr. The flow rate resulting from pumping on the system with mechanical vacuum pump 108 can be in the range of from about 0.5 liters per minute to about 30 liters per minute. NO light absorption spectrometer system 106 can be a mid-infrared tunable laser absorption spectrometer.

The invention provides a method and apparatus to measure NO concentration in orally exhaled human breath wherein a single breath is delivered to an NO analysis system through a tube at a reduced pressure provided by a vacuum pump at two different flow rates, a first flow rate and then at a second flow rate less than the first flow rate so that the patient need only provide a single breath exhaled normally through the mouth. The flow rates can be adjusted using the spectrometer computer. The time that the first flow rate is used can be in the range of from about 0.1 sec to about 10 sec. The second flow rate can be used for a time in the range of from about 5 sec to about 20 sec.

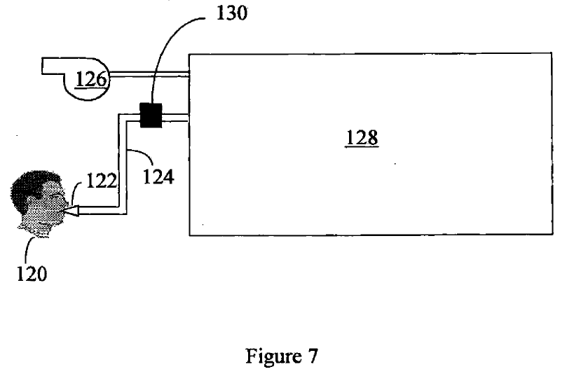

FIG. 7 shows human subject 120 orally exhaling a single breath as he or she would do when breathing normally into mouthpiece 122 connected to flow tube 124. Mechanical vacuum pump 126 is connected to NO analysis system 128 and flow tube 124 so that orally exhaled human breath flows through NO analysis system 128. Flow controller 130 can be adjusted using a computer in NO analysis system 128 to provide a desired flow rate. The first flow rate is in the range of from about 2 liters per minute to about 40 liters per minute and the second flow rate is in the range of from about 0.5 liters per minute to about 30 liters per minute. NO analysis system 128 can be a light absorption spectrometer, such as a mid-infrared tunable laser absorption spectrometer.

### EXAMPLE 1

The following example describes a liquid-N₂-free tunable laser absorption spectrometer (hereinafter “TLAS”) system equipped with a IV-VI laser operating near 5.2 μm for the purpose of analyzing eNO and exhaled CO₂ (eCO₂) simultaneously in expired breath. The system required no consumables other than disposable mouthpieces for breath analysis. Absorption measurements were performed using a 107-meter multipass White cell with a 16-liter volume. A closed-cycle cryogenic refrigerator was used to maintain cryogenic laser operating temperatures below 120 K. These refrigerators can dissipate about 5 watts of power at typical laser heat sink temperatures of ˜90 K. IV-VI lasers are well suited for cooling with such a system since they typically generate less than 1 watt of waste heat. The system further takes advantage of the ability of a single IV-VI laser to measure H₂O, CO₂, and NO in the same acquired signal sampling, thereby eliminating any need for introduction of additional calibration gases not originally present in the sample, reference cells, and reference detectors. A breath collection apparatus was fabricated to collect and sample breath in close accordance with the recommendations of the American Thoracic Society. Daily breath measurements from 5 individuals over a period of ten working days were performed. Daily eNO concentrations measured from the 5 individuals calculated using eCO₂ end-tidal absorption magnitudes as a reference calibration are compared to concentrations obtained by comparison with a calibrated NO gas standard. The effect of elevated NO levels in the ambient air on calculated eNO concentrations using eCO₂ as an internal reference calibration was also studied. To test the flexibility of the internal calibration scheme and to simulate measurements of a child's breath, an adult's breath was measured at different exhalation times from 5 to 20 seconds.

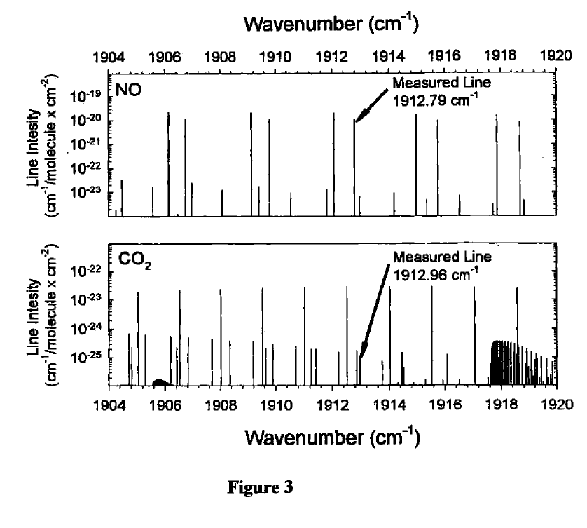

A brief discussion of specific absorption line attributes for the molecules of interest (NO, CO₂, and H₂O) between 1912.5 cm⁻¹ and 1913.0 cm⁻¹ is given. The R(10.5) NO lines located between 1912.7937 cm⁻¹ and 1912.7956 cm⁻¹ have a maximum absorption intensity of 1.032×10⁻²⁰ cm⁻¹/(molecule cm⁻²) and are separated by 0.05 cm⁻¹ from the nearest H₂O and CO₂ absorption lines. The single CO₂ absorption line P(6) at 1912.96 cm⁻¹ was measured and has a modest intensity of above 1.134*10⁻²⁵ cm⁻¹/(molecule cm⁻²). There is a second measurable CO₂ line located at 1912.69 cm⁻¹ with intensity of 1009×10⁻²⁶ cm⁻¹/(molecule cm⁻²). Also measured simultaneously along with CO₂ and NO is H₂O that has a strong absorption line located at 1912.5 cm⁻¹ with an intensity of 1.110×10⁻²³ cm⁻¹/(molecule cm⁻²). This unambiguous absorption is visible in exhaled breath and in ambient air. The 5.2 μm region contains adequate separation between NO, CO₂ and H₂O lines due mainly to the narrow spectral line widths of IV-VI laser emission. The NO and CO₂ absorption lines of interest between 1870 cm⁻¹ to 1940 cm⁻¹ obtained from the HITRAN database are shown in FIG. 3. There exist other possible candidate NO and CO₂ absorption lines for simultaneous measurements without interference from each other between 1895 cm⁻¹ and 1925 cm⁻¹, which are adequate for the eNO breath analysis procedure as described herein.

The TLAS system 41 is shown in FIG. 4. A single IV-VI laser 42 (Ekips Technologies, Norman, Okla.) with typical optical output power of 300 μW was mounted to a temperature-controlled stage not shown inside sealed cryostat 46 kept at cryogenic temperatures using a closed-cycle cryogenic refrigerator, not shown, rated for continuous maintenance free operation (CryoTigerm, APD Cryogenics, Allentown, Pa.) and pumped by ion pump 43. A laser beam represented by line 48 emitted from the IV-VI laser was first directed through a ZnSe window, not shown, and onto off-axis-parabolic mirror (OAPM) 50 to collimate the beam. A combination of flat and concave mirrors 52 was used to direct beam 48 through a 107-meter multipass White cell 54 (Infrared Analysis, Anaheim, Calif.). Upon exiting White cell 54, beam 53 was focused using ZnSe lens 55 and passed through a ZnSe window not shown onto HgCdTe mid-IR photovoltaic detector 56 also located inside cryostat 46. An integrated heater and temperature controller (Lakeshore, Westerville, Ohio), not shown, maintained stable laser operating temperatures at 102 K with an accuracy of ±0.01 K.

A low noise laser current driver in current driver and function generator assembly 58 controlled by personal computer 64 as indicated schematically by arrow 61 supplied currents between 800 mA and 900 mA. A sawtooth voltage ramp of 40 Hz and 0.11 Vₚₚ was used to tune the single mode laser emission from 1912.5 cm⁻¹ to 1913.0 cm⁻¹. Superimposed onto the sawtooth ramp is a smaller triangle waveform at 26.5 kHz and 0.01 Vₚₚ to modulate the laser emission frequency. The output of photovoltaic detector 56 is pre-amplified before a commercial lock-in amplifier 60 (Stanford Research Systems, Sunnyvale, Calif.) sampled the signal at twice the modulation frequency, a scheme known as second harmonic (2f) detection. A TTL signal from the 40 Hz ramp waveform generator was used to trigger the analog-to-digital (A/D) acquisitions of the output signal from the lock-in amplifier. Personal computer 64 controlled a 12-bit AiD converter card (National Instruments, Austin, Tex.) and acquired 500 data points per scan at a sampling frequency of 20 kHz. To reduce high frequency noise, 75 consecutive scans were co-averaged and then sent through a digital low pass Butterworth filter. The largest source of optical noise in the system was etalon fringes originating in White cell 54 and system optics.

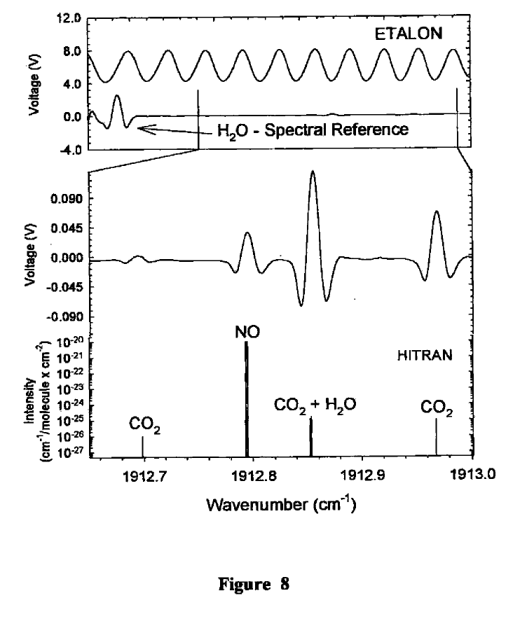

Spectral shifting of the spectrum can occur due to slight temperature variations of the heat sink for the laser. To counteract this shifting effect, the H₂O absorption peak at 1912.5 cm⁻¹ shown in FIG. 8, was used as a spectral reference to line up each spectrum before co-averaging to reduce smear and improve detection sensitivities. A custom software program was used to control the external functionalities of lock-in amplifier 60, function generators and current driver part of assembly 58 using IEEE-488.2 GPIB communications. The software also performed the co-averaging, filtering, and spectral analysis algorithms for determining concentrations based on breath eNO/eCO₂ ratios. A second harmonic spectrum of human breath containing peaks for NO, CO₂, H₂O, and associated MITRAN absorption line strengths is shown in FIG. 8.

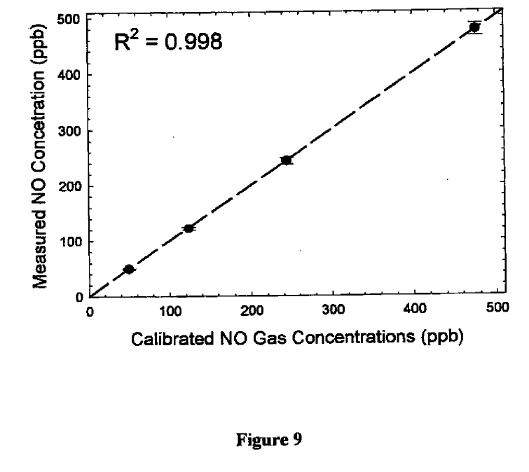

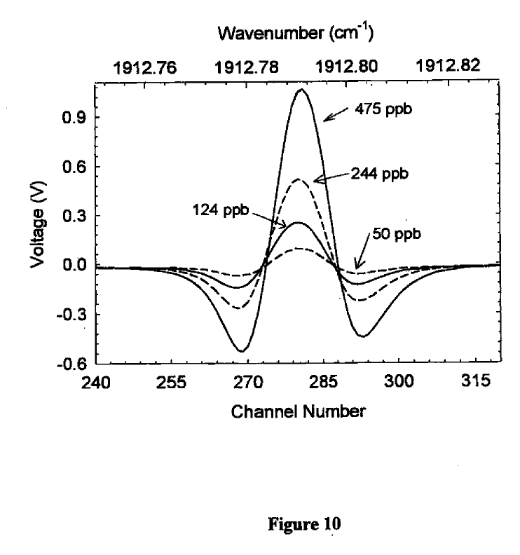

Second harmonic spectra contain absorption magnitudes that are directly proportional to concentrations of the associated molecular species. A calibration curve of the instrument was generated using a gas dilution system, which is designed for diluting a 10 ppm ±2% NO gas standard (Airgas, Mobile, Alab.), with purified N₂. Mass flow controllers located at the inlet to the White cell were used to mix various flows of NO with N₂ to achieve continuous flow concentrations from 10 ppm down to 20 ppb. To quantify concentrations, a comparison spectrum was collected at a known concentration of 50 ppb. The absorption magnitude of a 50 ppb NO comparison spectrum was then compared to subsequent absorptions of NO at diluted concentrations down to 20 ppb using a least squares fitting routine which will subsequently be described in detail The least-squares fitting routine returned the average absorption intensity over the entire absorption characteristic including both negative lobes, which is more accurate than just measuring the peak of the absorption. The calibration curve showing diluted NO gas standard calibrations vs. measured NO is shown in FIG. 9. The error bars for the points in FIG. 9 represent the standard deviation over 200 consecutive data points measured at each calibration concentration. The line shapes at differing concentrations are shown in FIG. 10. Measured NO absorption magnitudes have a strong linear relationship (R²=0.998) with calibrated NO concentrations. The minimum detection limit for a 4 second integration time (75 co-adds) was determined to be 1.5 ppb based upon the V_{RMS} noise in the baseline of the second harmonic spectrum. Further improvement of this figure of merit is possible using faster electronics to collect more spectra in a given time period.

Breath measurements were preformed at a pressure of 13 Torr to reduce line broadening and interference between NO, CO₂ and H₂O. Mechanical vacuum pump 64 including pump exhaust 65 shown in FIG. 10 induced flow through the gas cell at a constant rate of 2 L/minute using flow controllers, not shown. This rate of gas suction was comfortable for patients exhaling into the system over a period of 20 seconds or less. The breath collection device (Quintron, Milwaukee, Wis.) was designed to collect single-exhalations and consisted of T piece 66 connected to disposable mouthpiece 68, 500 mL discard bag 70, and ¼″ diameter Teflon tubing 72 directing breath through flow controllers not shown and into White cell 54. The discard bag accepted the first 500 mL of breath at little to no breathing resistance. This headspace breath contains a high concentration of NO originating from the nasal cavity. The remaining exhaled air enters the Teflon tubing at a constant rate of 2 L/min. Volunteers were instructed to exhale a single breath with force, which assisted in closing the velopharyngeal aperture limiting the entry of nasal NO via the posterior nasopharynx. A one-way flutter valve not shown located at the entrance to the discard bag prevented headspace breath from re-entering the breath collection system, and the discard bag was manually emptied after each exhalation. All breath measurements given in this report are single breath exhalations for 20 seconds unless otherwise stated. Institutional Review Board approval was granted from the University of Oklahoma for human subject research and each participant signed an informed consent form prior to donating breath.

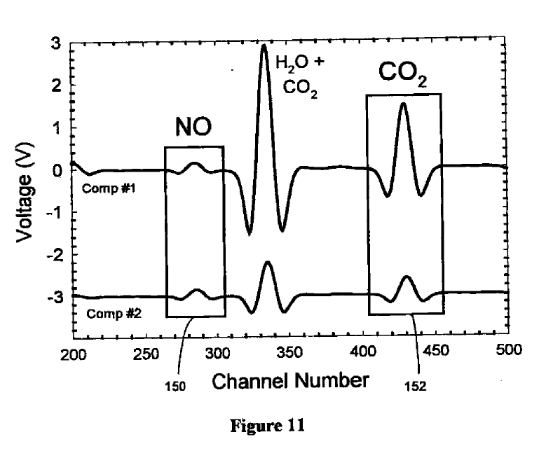

The magnitude of absorption due to breath eNO and eCO₂ was determined using a least-squares fining routine, which uses a comparison spectrum to analyze measured spectra during breath testing. Two comparison spectra, denoted as #1 and #2, at unknown different concentrations of NO and CO₂ are shown in FIG. 11. The rectangular windows encompassing the NO and CO₂ absorption define the windows 150 and 152, respectively, used to compare the comparison spectra to the measured spectra and encompass both negative lobes and the absorption peak. To characterize the relationship between the NO and CO₂ absorption profiles within each comparison, background spectra were subtracted from each comparison spectrum to eliminate any baseline offset. Next, the peak absorption voltages were determined to obtain a voltage ratio, (V_{NO}/V_{CO}_{₂}).

During breath donations, measured spectra containing the absorption for eNO and eCO₂ were compared to either comparison spectrum #1 or #2 using the least squares fitting routine. The measured absorption line contained in the set window for the sample (1) and the comparison (D) have a linear relationship of the form Yⱼ=a+bXₖ. Here, X and Y are the measured voltage amplitudes within a window containing the entire absorption characteristic including the negative lobes and some baseline on either side. The amplitude scaling factor, b, represents the absorption magnitude determined using the least squares method shown in Equation (1). The coefficient, a, represents baseline offset and is ignored. The index, j, in Equation (1) represents the position of the channel number in acquired spectra as shown in FIG. 10.

$$b = \frac{( \sum {Y}_{j} ) ( \sum {X}_{j} ) - N ( \sum {X}_{j} {Y}_{j} )}{{( \sum {X}_{j} )}^{2} - N ( \sum {X}_{j}^{2} )} \qquad EQ . ( 1 )$$

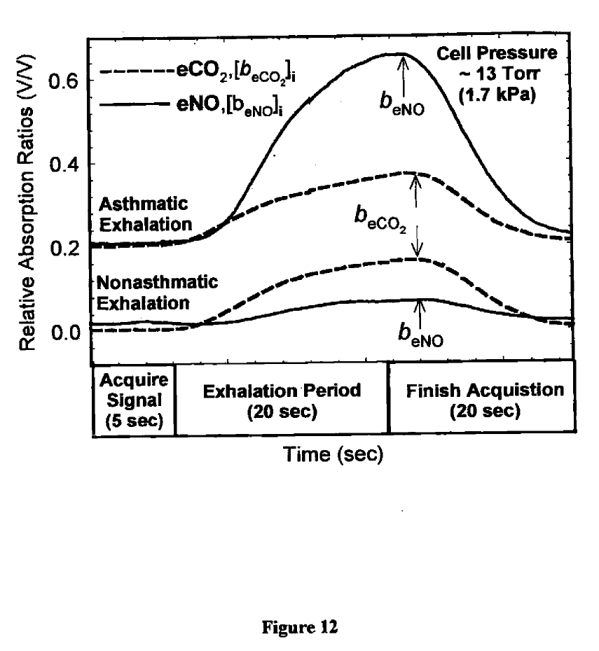

Example eNO and eCO₂ absorption magnitude arrays over time obtained for 20-second breath donations from a nonasthmatic and asthmatic volunteer are shown in FIG. 12. The end-tidal (or maximum) values in the plot of FIG. 12 occur after the end of the exhalation period because of short delays from gas exchange and software processing overhead Prior to exhalation, 5 seconds of NO and CO₂ measurements are performed and averaged to determine their absorption magnitudes in the ambient air. The absorption magnitude for eCO₂, b_{eCO}_{₂}, is determined by taking the end-tidal value in the exhalation trend array, [b_{eCO}_{₂}]ᵢ. The index, i, in the exhalation trend array denotes absorption magnitude data points collected over the breath analysis period. The maximum b_{eCO}_{₂} value is used to verify correct breath donation, This works as a good verification because eCO₂ concentrations are always greater than CO₂ concentrations in the ambient air, The absorption value in the [b_{eNO}]ᵢ array measured during the exhalation period that most deviates from the established baseline absorption magnitude for NO in the ambient is used to determine b_{eNO}. For determining b_{eNO}, it is not proper to use only the maximum value in [b_{eNO}]ᵢ because it is possible to have larger NO concentrations in the ambient air than in exhaled breath. Once b_{eNO} and b_{eCO}_{₂} have been determined, equation (2) is used to describe the overall absorption ratio, A_{eNO}/A_{eCO}_{₂}, relating the measured absorption magnitudes of analyzed breath samples to the voltage magnitudes of the comparison spectra.

$$\frac{{A}_{e NO}}{{A}_{{e CO}_{2}}} = \frac{{b}_{e NO}}{{b}_{{e CO}_{2}}} \times \frac{{V}_{NO}}{{V}_{{CO}_{2}}} \qquad EQ . ( 2 )$$

Utilizing known standard absorption line strengths (S(υ)) and pressure broadening coefficients (g) found in the HITRAN database, equation (3) can be used to relate the concentrations of eNO and eCO₂ in breath, where C_{eNO} and C_{eCO}_{₂} represent the concentration of eNO and eCO₂, respectively.

$${C}_{e NO} = ( \frac{{A}_{e NO}}{{A}_{{e CO}_{2}}} ) ( \frac{{g}_{NO}}{{g}_{{CO}_{2}}} ) ( \frac{{S ( υ )}_{{CO}_{2}}}{{S ( υ )}_{NO}} ) \times {C}_{{e CO}_{2}} \qquad EQ . ( 3 )$$

Equation (3) was derived using Beer's law and the fact that second harmonic spectra produce absorption magnitudes that have an approximate linear relationship with the concentration of the absorbing gas species. Equation (3) assumes that laser power is equivalent across both the NO and CO₂ absorption lines. To solve for C_{eNO}, it is assumed that eCO₂ concentrations are 4% since the typical value for exhaled C_{eCO}_{₂} in human breath is in the range of from about 4% to about 5%. Equation (3) is vulnerable to error if actual C_{eCO}_{₂} from an individual significantly deviates from the foregoing range. Slight variations (±10%) in actual C_{eCO}_{₂}, however, do not significantly affect the interpreted results because there is not a critical clinical importance at this time in obtaining high precision eNO concentrations. A 10% variation in eCO₂ concentration would give a typical error of about ±2 ppb in the calculated eNO concentration, which is much smaller than the difference between the eNO concentration ranges for asthmatics (30 ppb to 80 ppb) and nonasthmatics (5 to 20 ppb).

Results of testing five individuals (four nonasthumatics and one asthmatic) using comparison spectra #1 and #2 over a period of 10-days are presented. Calibrated eNO levels are compared to calculated eNO concentrations using equation (3). Also given are the results of studying different breath testing parameters including differing exhalation times, White cell pressures, and ambient NO levels.

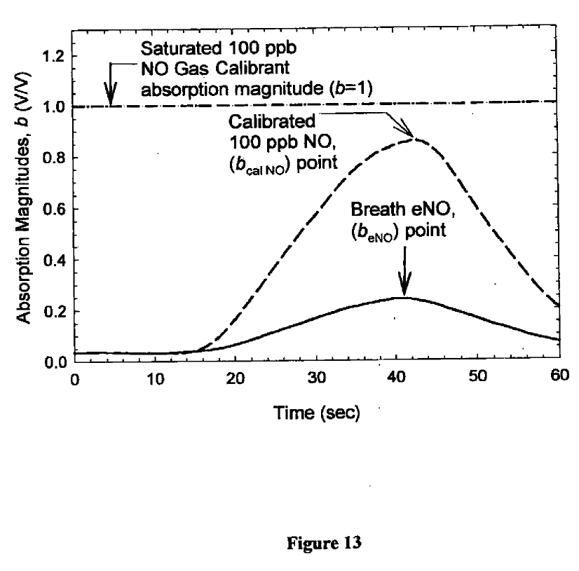

For comparison spectrum #1, each participant gave three breaths and the calculated eNO results using equation (3) were averaged over the three breaths. The same procedure was repeated using comparison spectrum #2. To perform calibration measurements for each participant, a diluted NO standard of 100 ppb was flowed through White cell 54 for 20 seconds, just as if a participant was exhaling. FIG. 13 shows a representative example concentration trend for calibrated NO flowing through the gas cell. The 100 ppb NO signal over the 20 second period was compared to a reference spectrum collected while White cell 54 was saturated with 100 ppb NO and the associated average absorption magnitude (b) was ˜1.0, as indicated in FIG. 13. The 100 ppb NO sample flow for 20 seconds does not completely saturate the White cell volume of 16 L at a gas exchange rate of 2 L/min, and a small software time constant due to data computational overhead does not allow b_{cal eNO} to completely reach 1.0. Immediately following analysis of the 100 ppb NO calibration gas, the volunteer exhaled into the system and the absorption magnitude for b_{eNO} was then compared to the 20 second 100 ppb calibration NO absorption magnitude, b_{cal NO}. The calibrated eNO concentration, C_{cal eNO}, was calculated using equation (4).

$${C}_{cal e NO} = ( \frac{{b}_{e NO}}{{b}_{cal NO}} ) \times ( 100 ppb Reference NO ) \qquad EQ . ( 4 )$$

Three sequential calibrated eNO breath measurements were performed and averaged to determine the calibrated eNO concentration, C_{col eNO}. It should be noted that a 16 L cell volume is suitable when discarding headspace, but smaller cell volumes are more desirable for rapid gas exchange rates and improved temporal resolution.

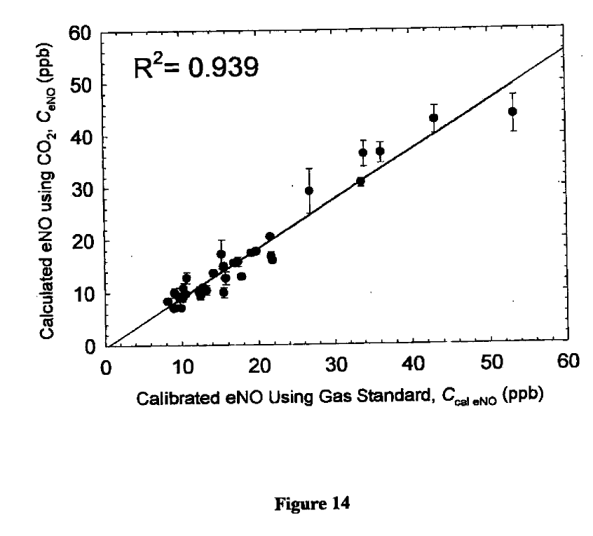

The five participants donated nine breaths daily over the period of ten working days (three breaths for comparison spectrum X1, three breaths for comparison spectrum #2, and three breaths for calibration). The relationship between calibrated eNO results vs. the calculated eNO results for comparison spectra #1 and #2 over the ten-day period are shown in FIG. 14 with error bars. There was a good linear relationship (R²=0.939) between the two methods showing that equation (3) using a 4% value for eCO₂ concentrations allowed accurate eNO measurements over the two-week testing period.

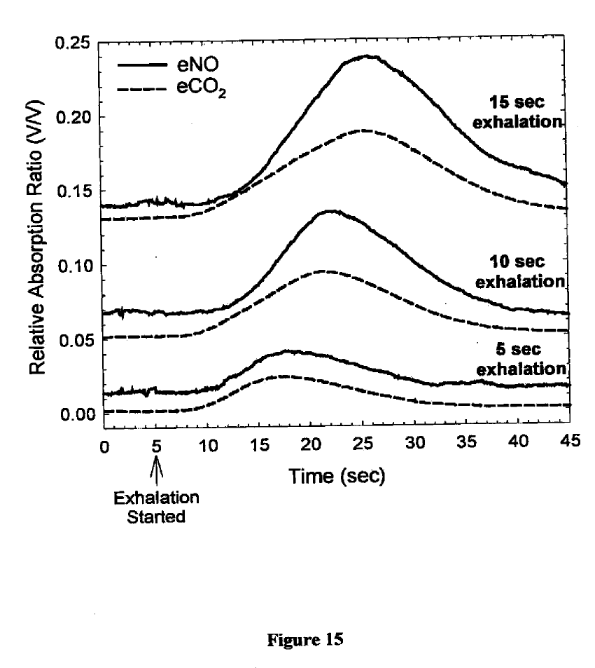

Adults found the 20 second exhalation time comfortable using a constant 2 L/min flow rate. The young, elderly, or ill, however, may find a 20 second exhalation period too long. FIG. 15 shows the results of an adult participant exhaling for periods of 15, 10 and 5 seconds, which would simulate breath collection from a child or adult with limited lung function. The longer the exhalation times, the stronger the measured signals due to more NO and CO₂ molecules occupying White cell 54. However, the eNO and eCO₂ ratios together help to compensate for variations in exhalation times and resulted in little variation in calculated eNO concentrations using equation (3), as shown in Table I.

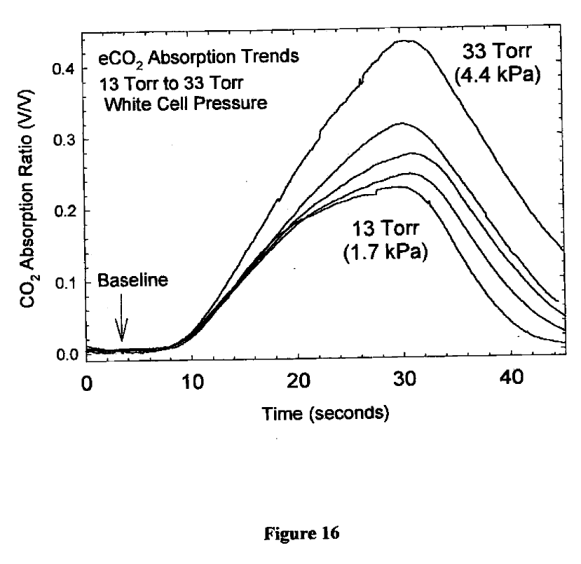

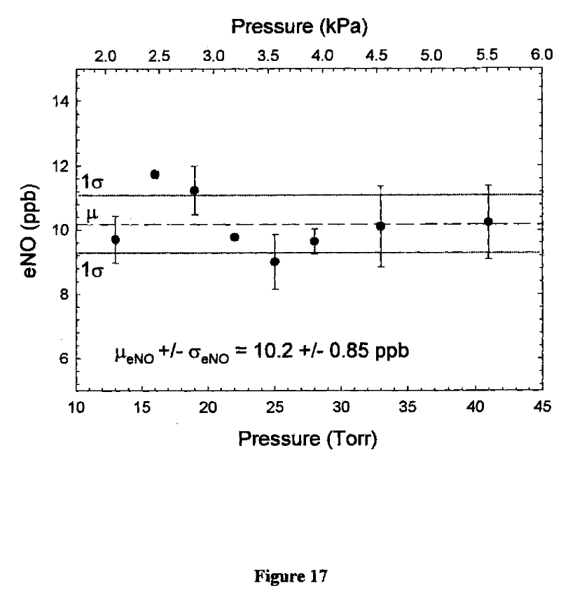

FIG. 16 shows eCO₂ trends from an individual exhaling at sample cell pressures ranging from 13 Torr to 33 Torr. As the pressure increases, the volume increases and the trends have a less apparent plateau because breath is not filling as much of the White cell volume. FIG. 17 shows the calculated eNO results versus pressure. Varying exhalation times and cell pressures do not appear to affect calculated eNO results significantly.

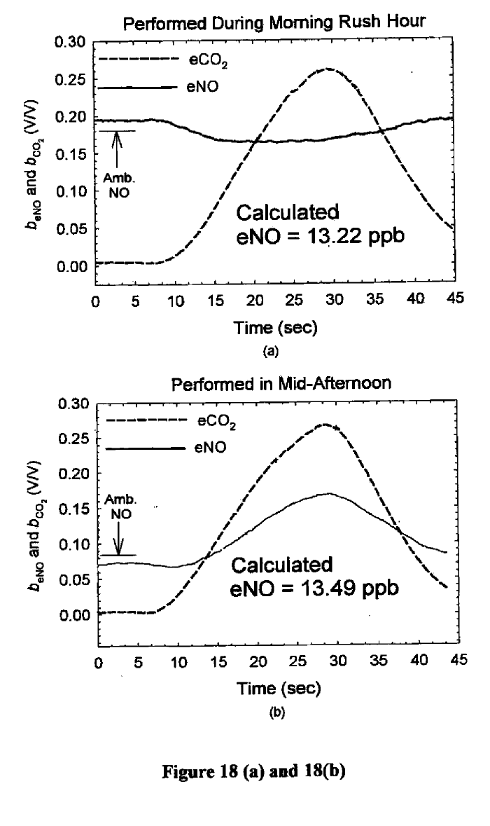

During the early morning and evening rush hours, NO levels in the ambient air have been observed to be as high as 200 ppb, due mainly to automobile exhaust. To test the effect of elevated ambient NO levels on measured eNO values, a volunteer donated breath in the morning when ambient NO levels were high, above 20 ppb, and again in the mid-afternoon when ambient levels were below 5 ppb. FIGS. 18(a) and 18(b) show the eNO and eCO₂ trends for both breath donations from the same volunteer. When NO concentrations in ambient air are larger than eNO in breath, breath eNO displaces ambient NO in the cell and the total concentration of NO in the cell goes down. Lower eNO concentrations than ambient NO concentrations suggest inhaled NO from the ambient air is rapidly absorbed by airway tissues and not subsequently exhaled. Recent in vivo measurements of NO and its chemical reaction products in human airways show that NO rapidly consumes reactive oxidative species (ROS) producing less reactive intermediate compounds such as ONOO— and ONOOH. This process leads to the accumulation of the innocuous product NO₃—. It is suggested that high eNO levels in the breath of asthma sufferers may actually be associated with a protective mechanism in which production of endogenous NO reduces the concentration of more damaging ROS that are also produced in the airways of individuals with asthma. The observation of exhaled NO concentrations that are lower than ambient levels shows that ambient (exogenous) NO is also rapidly consumed by airway tissues. It is not clear whether or not such consumption in the lungs of healthy or asthmatic individuals is beneficial.

Elevated ambient NO acts as a source of interference when using chemiluminescence; however, the breath collection method of the invention combined with a mid-IR TLAS system provided for repeatable eNO measurements regardless of high or low ambient NO concentrations. Since ambient NO concentrations are not a factor influencing reproducibility, the instrument may be operated in environments where air pollution effects are significant.

### EXAMPLE 2

The following example describes how the breath analysis method and apparatus of the invention may be used in a clinical setting to diagnose and monitor the efficacy of treatment of an asthmatic patient with anti-inflammatory therapy.

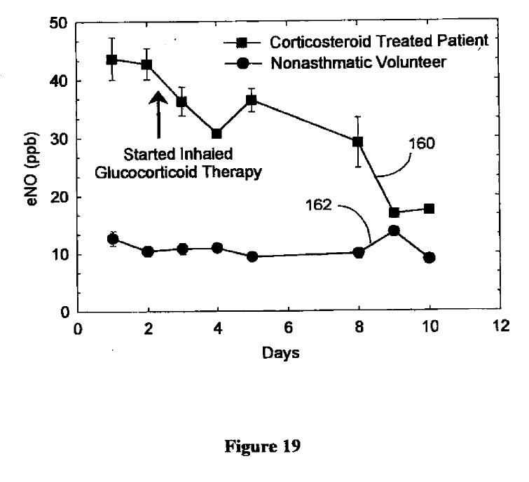

In FIG. 19, lower plot 162 shows eNO concentrations for a healthy volunteer indicating that eNO is below 20 ppb as expected in the absence of disease. Upper plot 160 shows eNO concentrations for a 42-year-old white male who initially did not carry a diagnosis of asthma. He did have a history of severe seasonal allergies including allergic rhinitis. The patient did experience intermittent chest “heaviness”, though he denied more obvious symptoms of the disease. His initial spirometry was normal, however, subsequent methacholine challenge testing was positive, indicating hyperactive airways and a likely diagnosis of asthma. The patient's eNO was found to be elevated (>40 ppb) and subsequently a trial of inhaled glucocorticoids was undertaken. As illustrated in FIG. 19, by the nine-day mark, the patient's eNO had dramatically fallen and was in the normal range of below 20 ppb. Despite his initial lack of symptoms, the patient subjectively felt much better when treated with the inhaled glucocorticoids.

Methacholine is a medication that will induce airway obstruction only in the presence of “hyper-reactive” airways. A positive test is indicated by a 20% fall in the measured baseline FEV1 (forced expired volume in one second). This has been the “gold standard” for establishing the diagnosis of asthma, a disease that can be quite variable in its presentation. Despite its utility, the methacholine challenge test is time consuming (˜1 hour), cumbersome, expensive to perform, and potentially risky because a bronchoconstrictive drug is administered. It certainly is not suitable for routine monitoring of the asthmatic. Unlike the methacholine test, the eNO test is fast, easy to perform, economical, and presents essentially no risk to the patient. It provides an assessment of underlying airway inflammation, which is a chronic condition in asthma patients. Other asthma diagnostic tests such as spiromet and peak flow measurement evaluate the airway constrictive component of the disease, a typically acute condition which may not be present during a clinical evaluation. The breath analysis method and apparatus of the invention and its ability to determine real-time eNO concentrations with ppb sensitivities provides a reliable clinical tool for the diagnosis and monitoring of asthma.

What is claimed is:

1. A spectrometer system for measuring the concentration of a marker gas in a gas mixture, the system comprising:
a spectrometer gas sample cell;
a spectrometer light source adapted to pass a light beam through the gas sample cell;
a spectrometer detector adapted to produce a signal sampling characteristic of the gas mixture in response to light passing through the gas mixture; and
a spectrometer computer adapted to acquire the signal sampling from the spectrometer detector over a signal acquisition interval and generate a gas mixture spectrum;
wherein the spectrometer computer is further adapted to analyze the gas mixture spectrum to determine a marker gas absorption intensity and a calibration gas absorption intensity as a function of time over a plurality of signal acquisition intervals to identify a signal acquisition interval where a known concentration calibration gas absorption intensity corresponds to an independently known calibration gas concentration and a simultaneous marker gas absorption; and to calculate a ratio of the simultaneous marker gas absorption intensity to the known concentration calibration gas absorption intensity and multiplying the ratio by a proportionality constant to determine concentration of the marker gas.

2. The system of claim 1 wherein the gas mixture sample comprises exhaled breath.

3. The system of claim 1 wherein the spectrometer gas sample cell has a pressure selected to reduce line broadening and interference between the marker gas absorption intensity and the calibration gas absorption intensity.

4. The system of claim 2 wherein the marker gas is characteristic of a disease.

5. The system of claim 1 wherein the marker gas comprises NO.

6. The system of claim 1 wherein the marker gas comprises H₂S.

7. The system of claim 1 wherein the marker gas comprises OCS.

8. The system of claim 1 wherein the calibration gas comprises CO₂.

9. The system of claim 1 wherein the calibration gas comprises H₂O.

10. The system of claim 1 wherein the spectrometer light source comprises a mid-infrared tunable laser.

11. The system of claim 1 wherein the spectrometer light source comprises an IV-VI diode laser.

12. The system of claim 11 wherein the IV-VI diode laser comprises an emission wavelength in the range of from about 3 μm to about 10 μm.

13. The system of claim 1 wherein the spectrometer gas sample cell comprises a Herriott cell.

14. The system of claim 1 wherein the spectrometer gas sample cell comprises a multi-pass White cell.

15. The system of claim 1 wherein the gas mixture spectrum generated by the spectrometer computer is a second harmonic absorption spectrum.

16. The system of claim 1 wherein the spectrometer computer is further adapted to calculate a running co-average of a plurality of signal samplings to obtain co-averaged signal samplings, and to digitally filter the co-averaged signal samplings to generate the gas mixture spectrum.

17. A method for comparing a concentration of a marker gas to a concentration of a calibration gas, wherein the calibration gas and marker gas are intrinsic in a gas sample and wherein the calibration gas has an independently known concentration, the method comprising:
placing the gas mixture sample in a spectrometer gas sample cell over a sampling interval;
illuminating the gas mixture sample within the spectrometer gas sample cell over the sampling interval to generate a signal sampling characteristic of the gas mixture sample;
generating a plurality of gas mixture spectra;
analyzing the gas mixture spectra to measure a marker gas intensity and a calibration gas intensity for each of the plurality of spectra as a function of time over the sampling interval to identify a single spectrum wherein a known concentration calibration gas intensity corresponds to an independently known calibration gas concentration and a simultaneous marker gas intensity; and
calculating a ratio of the simultaneous marker gas intensity to the known concentration calibration gas intensity and multiplying the ratio by a proportionality constant to determine concentration of the marker gas.

18. The method of claim 17 wherein said gas mixture sample comprises exhaled breath.

19. The method of claim 17 further comprising maintaining the spectrometer gas sample cell at a pressure selected to reduce line broadening and interference.

20. The method of claim 18 wherein the marker gas is characteristic of a disease.

21. The method of claim 20 wherein the marker gas comprises CH₃O.

22. The method of claim 20 wherein the marker gas comprises H₂S.

23. The method of claim 20 wherein the marker gas comprises OCS.

24. The method of claim 17 wherein the calibration gas comprises CO₂.

25. The method of claim 17 wherein the calibration gas comprises H₂O.

26. The method of claim 17 wherein illuminating the gas mixture sample comprises passing a mid-infrared tunable laser beam through the gas mixture sample.

27. The method of claim 26 wherein laser beam comprises an emission wavelength in the range from about 3 μm to about 10 μm.

28. The method of claim 17 wherein the spectrometer gas sample cell comprises a Herriott cell.

29. The method of claim 17 wherein the spectrometer gas sample cell comprises a multi-pass White cell.

30. The method of claim 17 wherein the gas mixture spectra comprise second harmonic spectra.

31. The method of claim 17 further comprising calculating a running co-average of the marker gas intensities and the calibration gas intensities over the sampling interval.
